(19) United States
(12) Patent Application Publication
(10) Pub. No.: US 2020/0171703 A1
(43) Pub. Date: Jun. 4, 2020

(54) Nozzle with Pressure and Force Sensing

(71) Applicants: Daniel Gelbart, Vancouver (CA); Oliver Jason Terry, Vancouver (CA)

(72) Inventors: Daniel Gelbart, Vancouver (CA); Oliver Jason Terry, Vancouver (CA)

(21) Appl. No.: 16/562,336

(22) Filed: Sep. 5, 2019

Related U.S. Application Data
(60) Provisional application No. 62/770,598, filed on Nov. 21, 2018.

(51) Int. Cl. B28B 17/00; B05B 12/00; B05B 15/14; B33Y 30/00; B33Y 50/00; B28B 1/00; B22D 23/00

(52) U.S. Cl. CPC B28B 17/00; B05B 12/008; B05B 15/14; B33Y 10/00; B33Y 50/00; B28B 1/001; B22D 23/003; B33Y 30/00

(57) ABSTRACT

A pressure detector is installed in close proximity to the nozzle of a 3D printer and detects a plugged nozzle by the sudden increase in the pressure of the extruded material. The printing process is paused until the nozzle is cleared manually or automatically. For manual cleaning a notification can be automatically sent to the user of the printer. The pressure sensor can be part of the nozzle housing and be designed to detect external forces as well, in order to serve as a bed levelling sensor.

### FIELD OF THE INVENTION

The invention relates mainly to 3D printing, but can be used in any device having a nozzle that may plug or needs registration.

### BACKGROUND

A common method of 3D printings, also known as Additive Manufacturing, is to extrude a paste-like material through a small nozzle to build up an object layer by layer. The most common type of 3D printers melts a plastic filament, or a filament containing plastic and metal powder, and pushes the molten paste through the nozzle. In such printers it is possible to detect a plugged nozzle by the fact that the filament stopped moving or needs an increased force to move. Such a system is disclosed in US patent application 20190030818. In printers that use a paste, but do not rely on melting a filament, it is difficult to detect a plugged nozzle, as the paste is fed under a high pressure even if the nozzle is not plugged. The plugged nozzle sensor, if based on pressure, has to be mounted as close as possible to the nozzle. It is not possible to transmit the pressure via a thin tube as the paste will solidify in the tube and plug it. The sensor should also trap the smallest possible amount of paste for ease of cleaning. If a plugged nozzle can be detected immediately, it can be cleared manually or automatically and the printing can proceed. If a plugged nozzle is not detected, the printed object is ruined.

In 3D printing the initial distance from the nozzle and the “bed” (the plate on which the printed object is being deposited) is most critical. Prior art 3D printers use an electrical switch to sense the bed position in different parts of the bed and perform a “bed levelling” procedure. Any mechanical offset between the electrical switch and the nozzle tip will cause an error. The ideal sensor for bed position would be the nozzle tip, as no offset can occur. The current invention allows this feature using the same sensor and circuit as the plugged nozzle detection.

### SUMMARY OF THE INVENTION

A pressure detector is installed in close proximity to the nozzle of a 3D printer and detects a plugged nozzle by the sudden increase in the pressure of the extruded material. The printing process is paused until the nozzle is cleared manually or automatically. For manual cleaning a notification can be automatically sent to the user of the printer. The pressure sensor can be part of the nozzle housing and e designed to detect external forces as well, in order to serve as a bed levelling sensor.

### BRIEF DESCRIPTION OF THE DRAWING

FIG. 1 shows a cross section of the extrusion nozzle of a 3D printer for printing metal and ceramic pastes, including an automatic nozzle cleaning mechanism.

FIG. 2 shows a cross section of a nozzle with a deformable front, deformation being measured by a strain gage.

FIG. 3A shows a cross section of the normal operating mode, with no deformation.

FIG. 3B shows a cross section of a plugged nozzle, with the front surface deformed outwards.

FIG. 3C shows a cross section of the nozzle when used as a bed levelling sensor, with the front surface deformed inwards when touched by the printer bed.

FIG. 4 is an electrical schematic of the strain gage amplifier.

### DETAILED DISCLOSURE

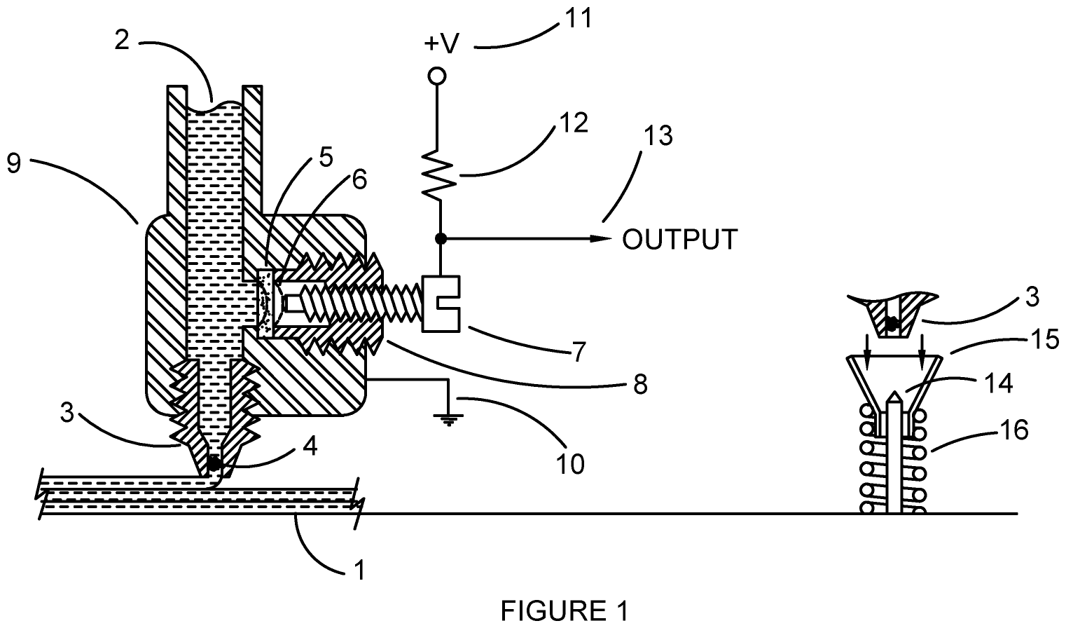

Referring to FIG. 1, a pressurized thick paste 2 is extruded via nozzle 3 to build up an object 1, layer by layer. The inside diameter of nozzle 1 is typically 0.3 mm to 1 mm. When paste 2 is a metal or ceramic paste a blockage 4 can easily be formed inside nozzle 3. When nozzle 3 is not plugged, the pressure near the tip of the nozzle is low, typically 0.1-1 MPa, as the nozzle is open to the atmosphere. The pressure is much higher even a short distance before the nozzle because of the high viscosity of the paste. Because of this, a regular pressure switch or sensor can not be used, as the pressure has to be measured as close as possible to the nozzle opening, typically between 1 to 10 mm from nozzle opening. A pressure sensor can not be connected to the nozzle via a thin tube as the tube is as likely to plug as the nozzle.

The pressure sensor shown in FIG. 1 is built directly into the nozzle housing 9. A flexible disc 5 is made from electrically conductive rubber and clamped to conductive housing 9 by an electrically insulating screw 8. A second screw, made of an electrically conductive material, is adjusted not to make electrical contact with disc 5 under normal condition. When nozzle is plugged by object 4, the increased pressure near the nozzle causes disc 5 to deform into a convex shape 6 and to touch screw 7, thus completing an electrical path between screw 7 and nozzle housing 9. Housing 9 is grounded via wire 10. A resistor 12 and voltage source 11 create an output voltage 13 as long as there is no overpressure detected. When nozzle 3 plugs, disc 5 will short screw 7 to ground potential and output 13 will go to zero.

In the preferred embodiment housing 9 is made of stainless steel, screw 8 is made of polyimide (Vespel or similar), screw 7 is made of stainless steel and conductive disc 5 is made of the conductive rubber commonly used for RF gaskets. These conductive rubbers are regular or silicone rubber compounds mixed with metal powder, such as nickel powder. They are readily available from RF gasket suppliers such as www.rubbercraft.com. For higher pressure a thin flexible metal disc can be used, made from BeCu or stainless steel. Typical diameter of disc 5 is 2-5 mm and the thickness is 0.3-1 mm. For a metal disc the typical thickness is 10-100 um.

When a nozzle plugging is detected an alarm can sound or a message (such as a mobile phone text message) can be automatically sent to the printer user. Automatic nozzle unplugging, by inserting a metal pin into the nozzle, can also be used. A metal pin 14 of a diameter slightly smaller than the nozzle is located outside the printed object. Since a 3D printer provides relative motion between the nozzle and the printed object, same motion can be used to position the plugged nozzle above pin 14 and push the pin into the nozzle. If unplugging is successful, output 13 will go to voltage V again. In order to minimize the placement accuracy required in placing the nozzle over the pin, a guide taper or funnel 15 is provided, spring loaded by spring 16. As the nozzles moves into funnel 15 the nozzle and the cleaning pin 14 are aligned. The process can be tried several times. If it fails, an alarm or message is activated.

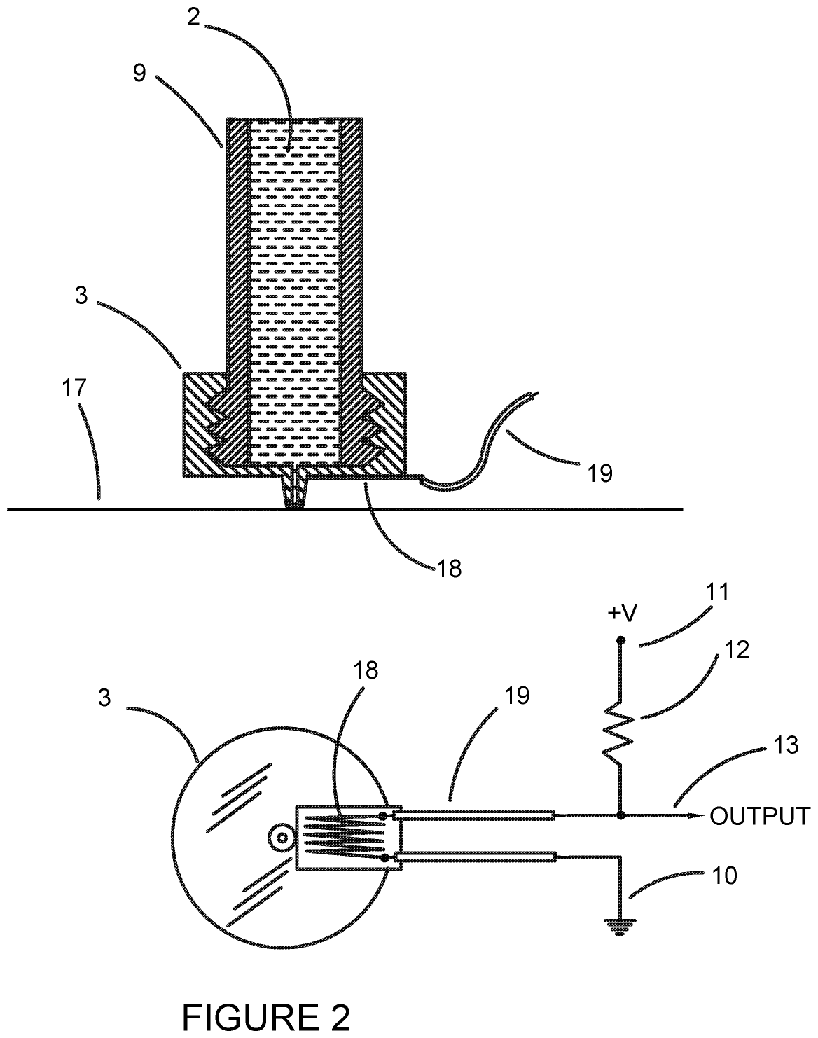

An alternate embodiment shown in FIG. 2 has the additional advantage that the same sensor can be also used as a bed levelling sensor to level bed plate 17. Referring now to FIG. 2, The front part of nozzle 3 is made of thin material to render it deformable. A strain gage 18 is bonded to the front surface of nozzle 3 and connected via conductors 19 to a voltage source 11 via resistor 12. Deforming the nozzle front changes the resistance of strain gage 18 and output voltage 13. The art of using strain gages is well known. The actual deformations involved are very small, a tiny fraction of one millimeter, and the changes in the resistance of the strain gage are equally small, typically less than 0.1%, but can be amplified and detected.

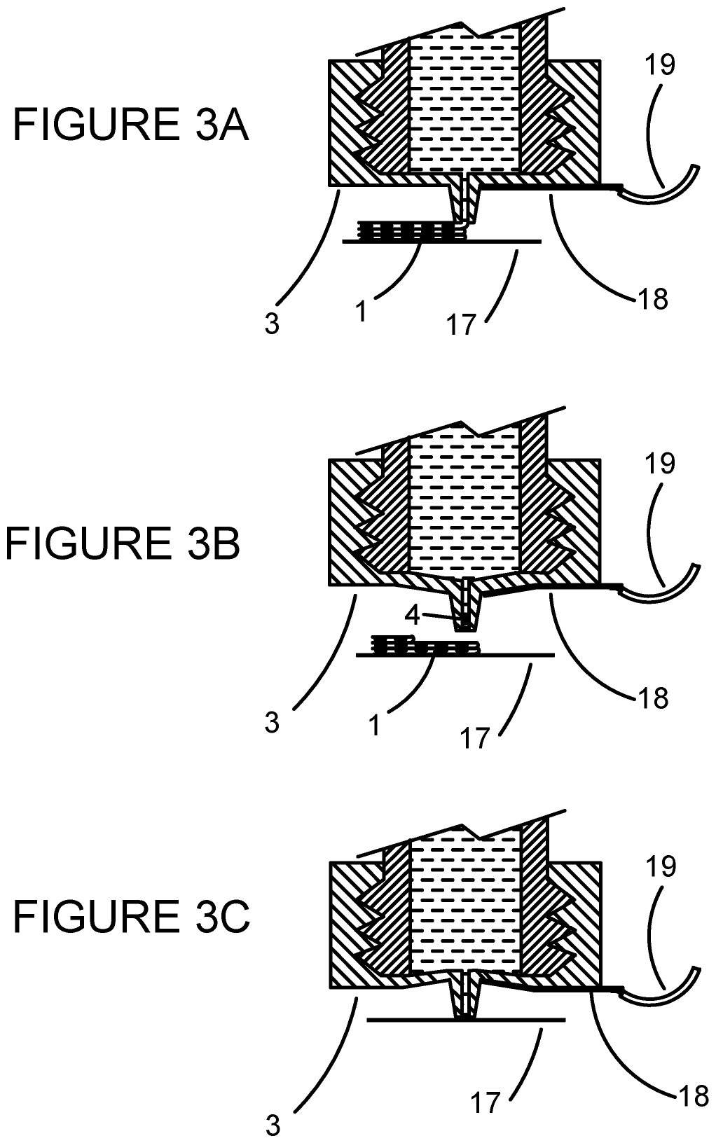

FIG. 3A shows a cross section of the nozzle under normal operating conditions. The extruded paste forms object 1, layer by layer, on bed plate 17. Since the nozzle is open, the pressure of the paste near the nozzle is low and the front of the nozzle is not deformed. FIG. 3B shows a nozzle plugged by object 4, causing increased paste pressure which deforms the thin nozzle front to bulge outwards. This deformation is detected by strain gage 18. FIG. 3C shows how the same nozzle can be used for bed levelling. When bed 17 is pressed against nozzle 3, the front part deforms inwards. This deformation is detected by strain gage 18 and used to sense the moment the bed touched the nozzle. The tip of the nozzle acts as the sensor tip. Since the same tip is extruding the paste, no offset error can develop between the sensing and the extrusion. The strain gage resistance will also change if sideways pressure is applied to the nozzle tip. This allows to use the same circuit as a collision detector.

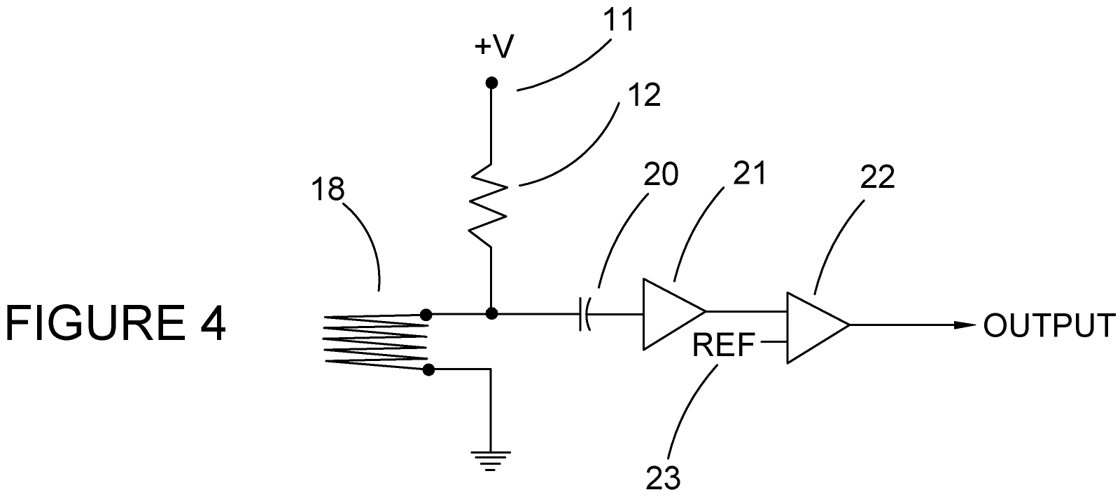

Because of the small resistance changes involved, the signal created by the deformation can be masked by electrical drifts in the detection circuit and the resistance changes caused by the changing temperature of the nozzle. Fortunately, the sensor resistance changes caused by plugging or bed levelling are much faster than the changes caused by drifts. Plugging and touching create changes in one second or less, while drift (both temperature and electronic sources) takes many minutes to develop. This allows to easily separate the desired signal by using an electrical high pass filter with a cut-off frequency of about 0.3-3 Hz. This filter can also be implemented in software, by monitoring the output and ignoring slow changes. A suitable circuit is shown in FIG. 4. Resistor 12 and strain gage 18 form a voltage divider. For best sensitivity, resistor 12 should have the same resistance as strain gage 18. The high-pass filter is formed by coupling capacitor 20. The signal is amplified by amplifier 21, followed by a comparator 22. The reference voltage 23 of comparator 22 can be fixed or programmable. Such strain gage circuits are well known in the art and commercially available. The comparator output will change when nozzle is plugged or pressed against an object.

By the way of example, nozzle 3 is 14 mm diameter with the deformable front has a thickness of 0.1-0.5 mm. It is made of hardened 440C stainless steel. The strain gage is a standard 350 Ohm 4×6 mm sensor and the amplifier has a gain of 1000. A 100 gram force produces a signal of 10-100 mV at amplifier output. Because of the coupling capacitor the signal is bipolar, allowing a single threshold to detect both inward and outward deformations.

If only the bed levelling function is desired, strain gage 18 does not need to be mounted on nozzle 3 but can be mounted on any part of the 3D printer that will deform when the bed is pressed into the nozzle.

1. A method of detecting the plugging of an extrusion nozzle in a 3D printer by sensing the pressure of the extruded material in close proximity to the nozzle.

2. A method as in claim 1 wherein said sensing is performed by a strain gage bonded to a deformable part of said nozzle.

3. A method as in claim 1 wherein said sensing is performed by a closing an electrical circuit by a deformable part of said nozzle.

4. A 3D printer nozzle comprising a strain gage for measuring deformation in a part of said nozzle.

5. A nozzle as in claim 4 wherein the said deformation measurement is used to detect nozzle plugging.

6. A nozzle as in claim 4 wherein the said deformation measurement is used to detect contact between the nozzle and the printer bed.

7. A nozzle as in claim 4 wherein the said deformation measurement is used to detect a collision between the nozzle and other objects.

8. A method for bed levelling in a 3D printer having a nozzle extruding material onto a bed, the method is based on detecting contact between the extrusion nozzle and the printer bed.

9. A method as in claim 8 wherein said contact is sensed by measuring deformation in a part of said nozzle.

10. A method as in claim 2 wherein the strain gage is coupled to an amplifier via a high pass filter.

11. A method as in claim 2 wherein the strain gage output is processed by software to form the equivalent of a high pass filter.

12. A method as in claim 4 wherein the strain gage is coupled to an amplifier via a high pass filter.

13. A method as in claim 4 wherein the strain gage output is processed by software to form the equivalent of a high pass filter.
